(19) United States
(12) Patent Application Publication
(10) Pub. No.: US 2016/0068049 A1
(43) Pub. Date: Mar. 10, 2016

(54) Windscreen for A Vehicle

(71) Applicant: Anthony Rich, Wallingford, CT (US)

(72) Inventor: Anthony Rich, Wallingford, CT (US)

(21) Appl. No.: 14/817,622

(22) Filed: Aug. 4, 2015

Related U.S. Application Data
(60) Provisional application No. 62/033,011, filed on Aug. 4, 2014.
(60) Provisional application No. 62/046,668, filed on Sep. 5, 2014.

(51) Int. Cl. B60J 1/00

(52) U.S. Cl. CPC B60J 1/008

(57) ABSTRACT

A vehicle windscreen for use with a vehicle having handle bars is provided and includes a screen top, a screen bottom, wherein the windscreen includes a screen height which extends between the screen top and the screen bottom, a first screen side, a second screen side, wherein the windscreen includes a screen width which extends between the first screen side and the second screen side, a screen interior surface and a screen exterior surface, wherein the screen exterior surface is arcuately shaped such that the screen exterior surface includes a first continuous curve between the first screen side and the second screen side and a second continuos curve between the screen top and the screen bottom.

### CROSS-REFERENCE TO RELATED APPLICATIONS

This application is related to U.S. Provisional Patent Application Serial Nos: 62/033,011 filed Aug. 4, 2014 and 62/046,668 filed Sep. 5, 2014, the contents of both of which are incorporated herein by reference in their entireties.

### FIELD OF THE INVENTION

This invention relates generally to the open cabin motorized vehicles, such as motorcycles, snowmobiles, etc. and more particularly to a windscreen for motorized vehicles.

### BACKGROUND OF THE INVENTION

Windscreens for motorized vehicles where the driver and passengers are in the open air are well known and have been in use for several decades. These windscreens help to buffer and protect the rider from rushing air, debris that is kicked up from other vehicles, bugs, rain and other items that are in the path of the vehicle and that may impact the rider. The windscreen also serves to insulate the rider from cold air and reduce the amount of noise that the rider experiences.

Unfortunately however, current windscreen designs either fail to provide adequate protection to the rider or it increases the amount of aerodynamic drag on the motorcycle. For example, some windscreens are available with an aerodynamic shape that conform to the shape of the front of the motorcycle and that have low profile, while other windscreens have a high profile and are less aerodynamic. As such, the rider is either subjected to excessive noise, wind currents and debris kick-up from the road or an additional limitation on the speed capability of the motorcycle due to drag. Both of these events are undesirable because they can cause the rider to lose control of the motorcycle during operation.

### SUMMARY OF THE INVENTION

A vehicle windscreen for use with a vehicle having handle bars is provided and includes a screen top, a screen bottom, wherein the windscreen includes a screen height which extends between the screen top and the screen bottom, a first screen side, a second screen side, wherein the windscreen includes a screen width which extends between the first screen side and the second screen side, a screen interior surface and a screen exterior surface, wherein the screen exterior surface is arcuately shaped such that the screen exterior surface includes a first continuous curve between the first screen side and the second screen side and a second continous curve between the screen top and the screen bottom.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike:

FIG. 1 is a front view of a windscreen attached to a motorcycle, in accordance with one embodiment of the invention.

FIG. 2 is a top down view of one of the mounting brackets used to attach the windscreen of FIG. 1 to a motorcycle, in accordance with one embodiment of the invention.

FIG. 3 is a top down view of one of the mounting brackets used to attach the windscreen of FIG. 1 to a motorcycle, in accordance with one embodiment of the invention.

FIG. 4 is a top down view of one of the mounting brackets used to attach the windscreen of FIG. 1 to a motorcycle, in accordance with one embodiment of the invention.

FIG. 5 is a rear view of the windscreen of FIG. 1 attached to a motorcycle, in accordance with one embodiment of the invention.

FIG. 6 is a rear view of the windscreen of FIG. 1 attached to a motorcycle, in accordance with one embodiment of the invention.

FIG. 7 is a rear view of one of the mounting brackets used to attach the windscreen of FIG. 1 to a motorcycle, in accordance with one embodiment of the invention.

FIG. 8 is a top down view of one of the mounting brackets used to attach the windscreen of FIG. 1 to a motorcycle, in accordance with one embodiment of the invention.

FIG. 9 is a rear view of the windscreen of FIG. 1 attached to a motorcycle, in accordance with one embodiment of the invention.

FIG. 10 is a top down rear view of one of the mounting brackets used to attach the windscreen of FIG. 1 to a motorcycle, in accordance with one embodiment of the invention.

FIG. 11 is a front view of one of the mounting brackets used to attach the windscreen of FIG. 1 to a motorcycle, in accordance with one embodiment of the invention.

FIG. 12 is a top down front view of one of the mounting brackets used to attach the windscreen of FIG. 1 to a motorcycle, in accordance with one embodiment of the invention.

FIG. 13 is a side view of the windscreen of FIG. 1 attached to a motorcycle, in accordance with one embodiment of the invention.

FIG. 14 is a front view of the windscreen of FIG. 1 attached to a motorcycle, in accordance with one embodiment of the invention.

FIG. 15 is a rear view of the windscreen of FIG. 1 attached to a motorcycle, in accordance with one embodiment of the invention.

FIG. 16 is a graphic image showing the radius of arc segment for one embodiment of the invention.

FIG. 17 is a rear view of the windscreen of FIG. 2, in accordance with one embodiment of the invention.

FIG. 18 is a top down sectional view of the windscreen of FIG. 17, in accordance with one embodiment of the invention.

FIG. 19 illustrates how to calculate the radius of the windscreen, in accordance with one embodiment of the invention.

FIG. 20 is a rear view of a windscreen of FIG. 2, in accordance with another embodiment of the invention.

### DETAILED DESCRIPTION OF THE INVENTION

It should be appreciated that a windscreen is provided, in accordance with the present invention, wherein the windscreen dramatically reduces wind noise while riding and protects the rider from the harmful effects of prolonged exposure to wind noise, effectively reducing and/or eliminating the need for hearing protection and reducing buffeting. The windscreen of the present invention allows the rider to experience an enhanced listening environment, wherein the use of this windscreen will enable the rider to hear very distinctive sounds that are currently very difficult to hear while riding, such as, for example, specific mechanical sounds/tics of the engine, tires rolling on ground, sand versus blacktop or dirt etc., exhaust, even being able to hear oneself talking out loud, or the ability to hear a passenger without a microphone system. The windscreen of the present invention also serves to dramatically increase/enhance the field of vision of the rider by offering an unobstructed protected view, which enables the rider to see more clearly, the road ahead, versus traditional windscreen designs.

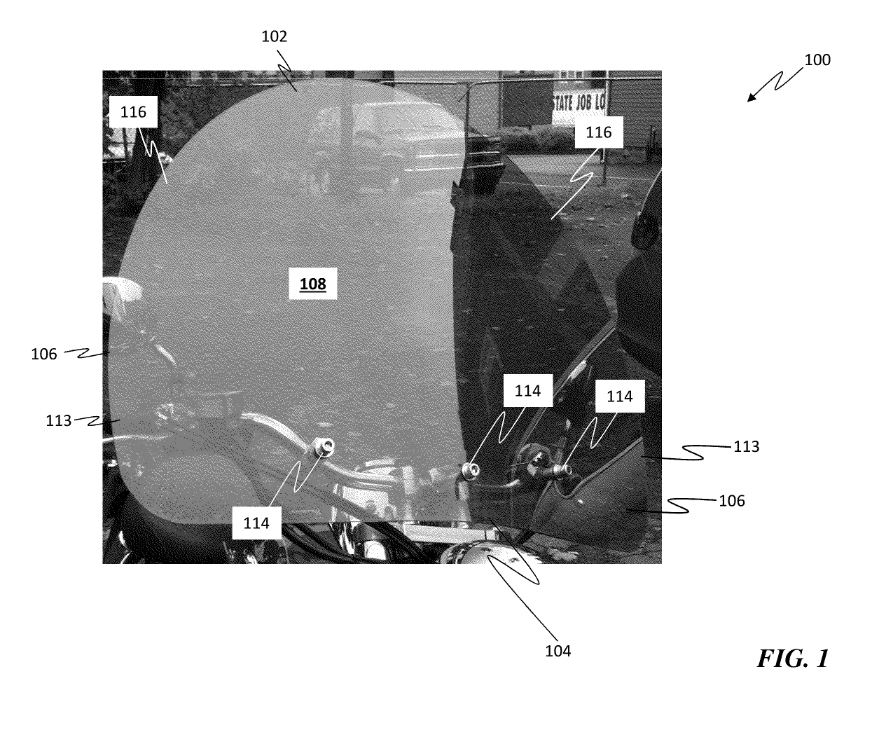

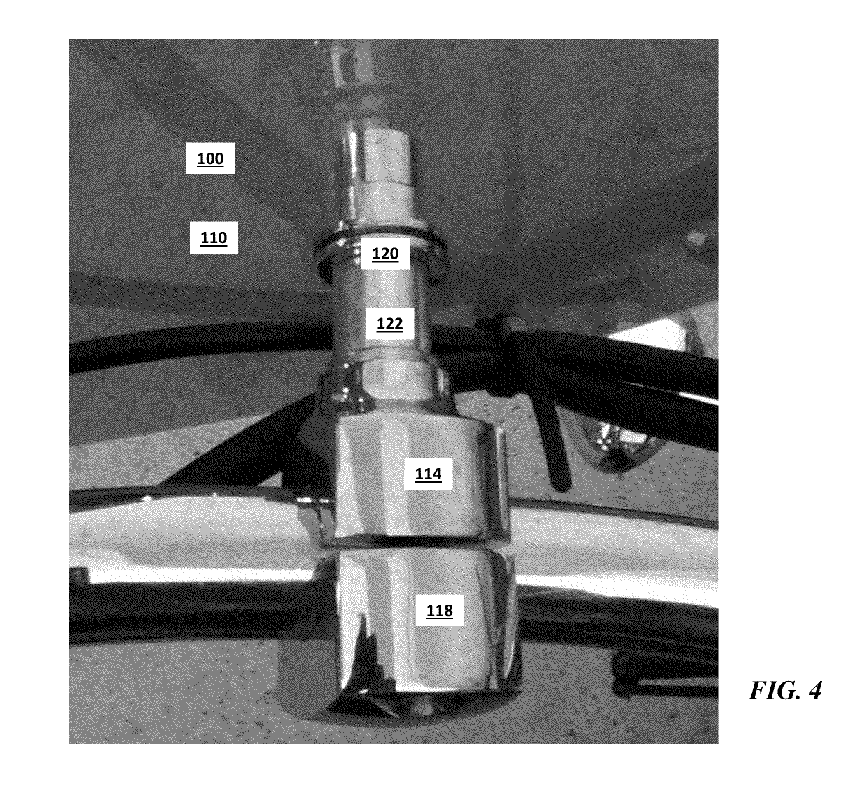

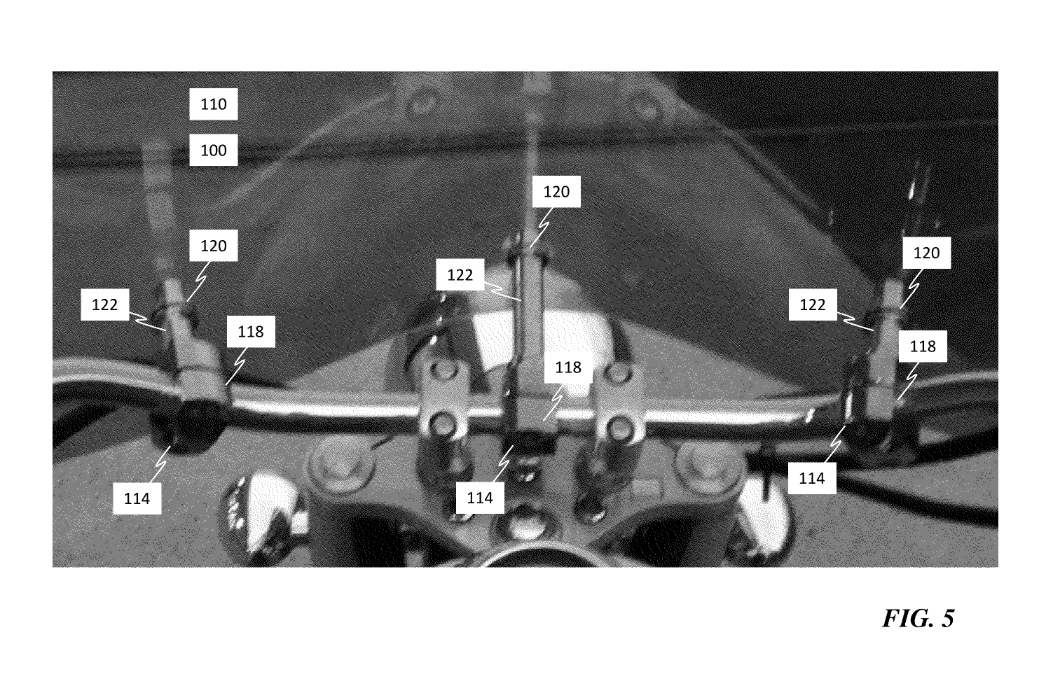

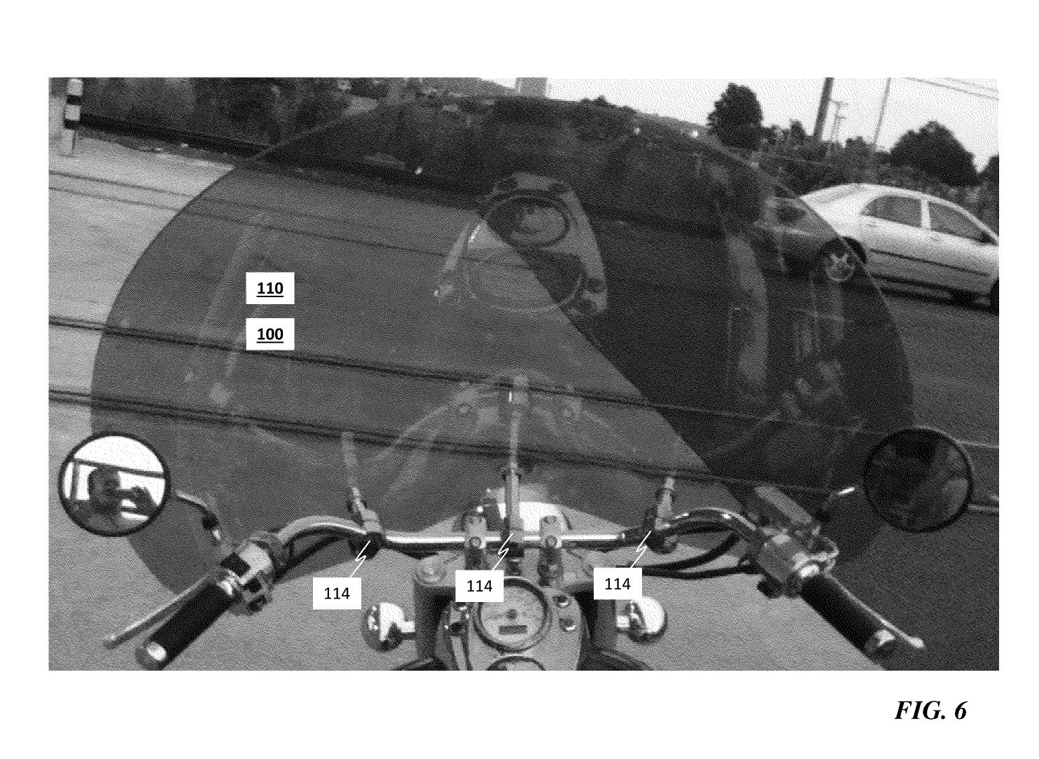

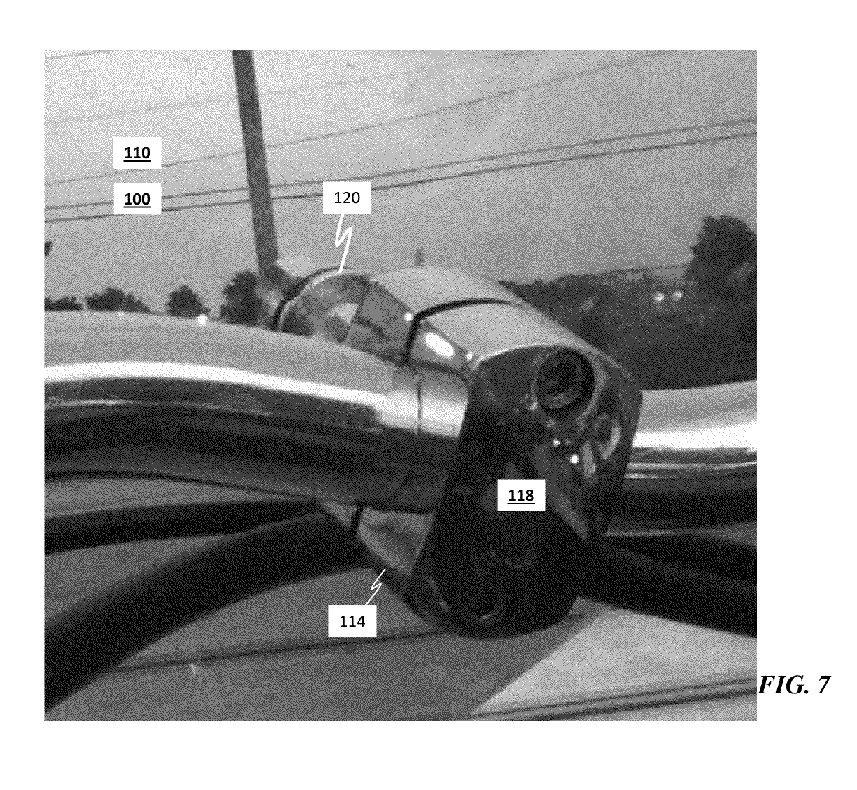

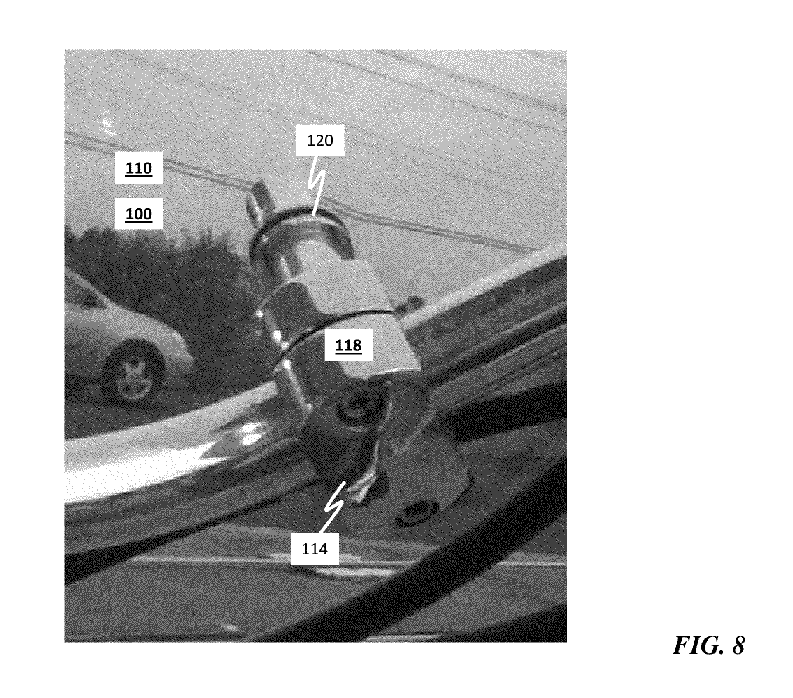

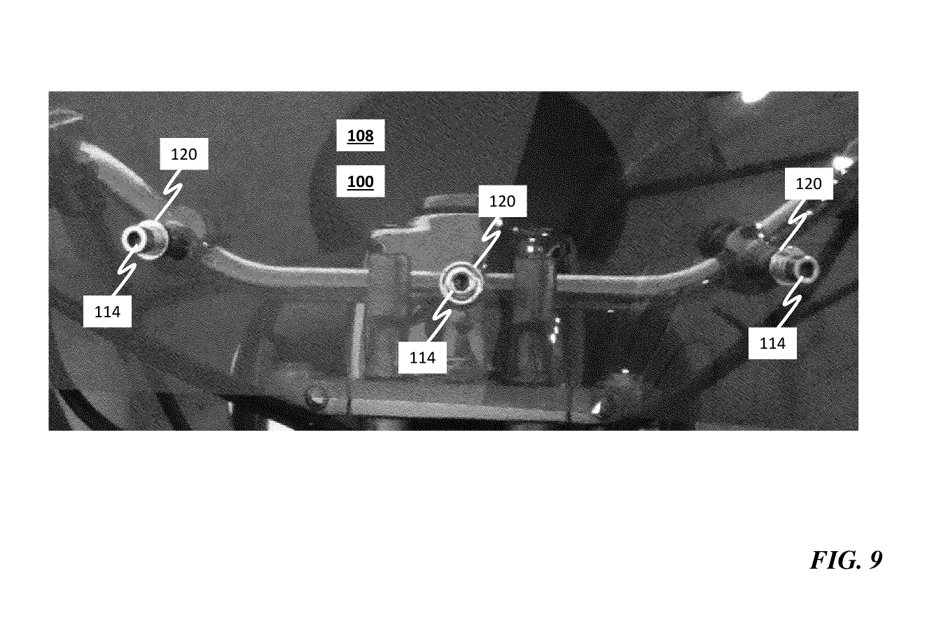

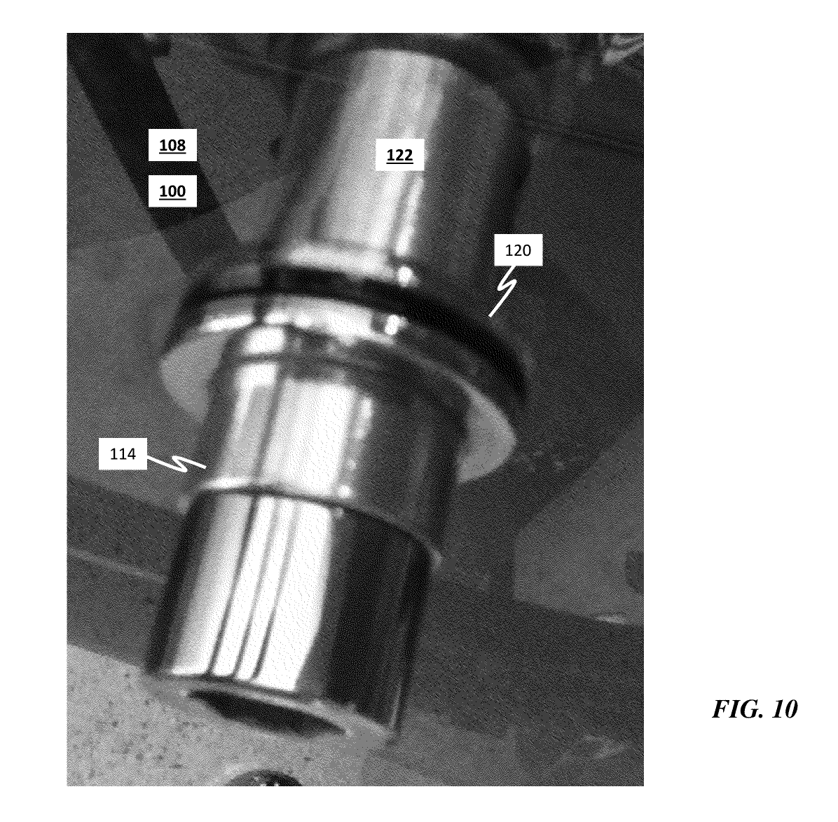

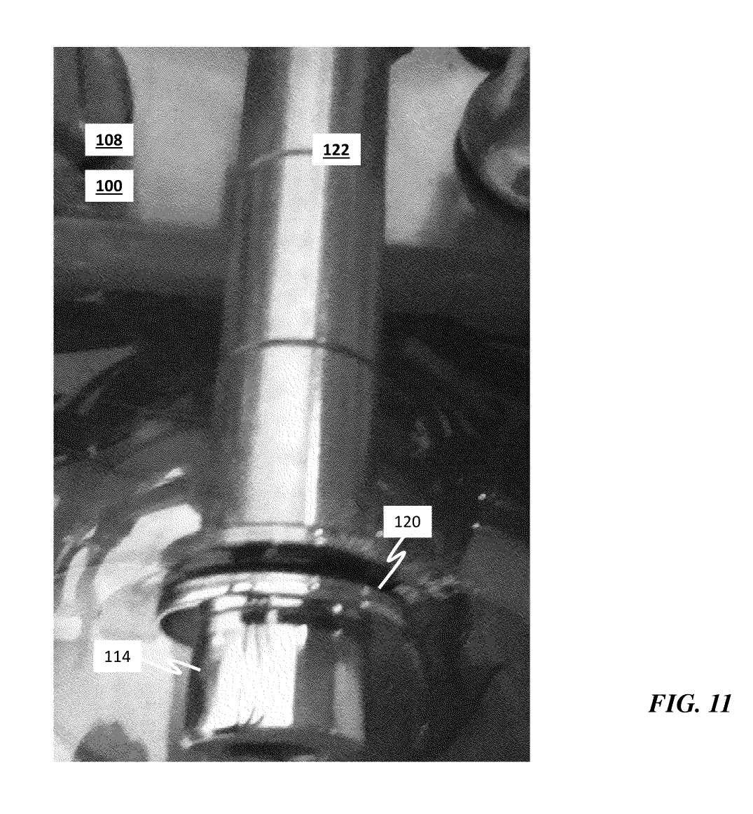

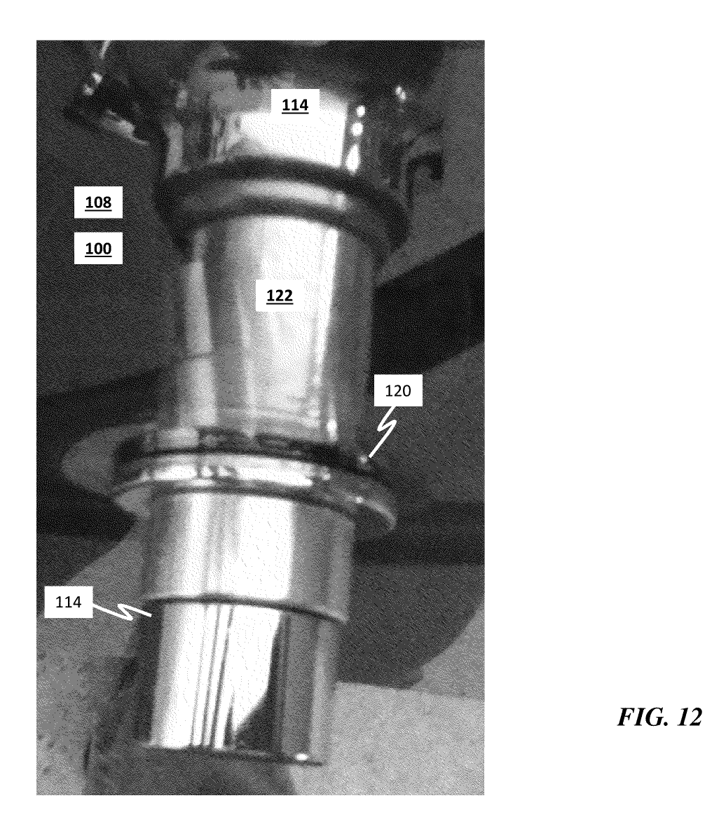

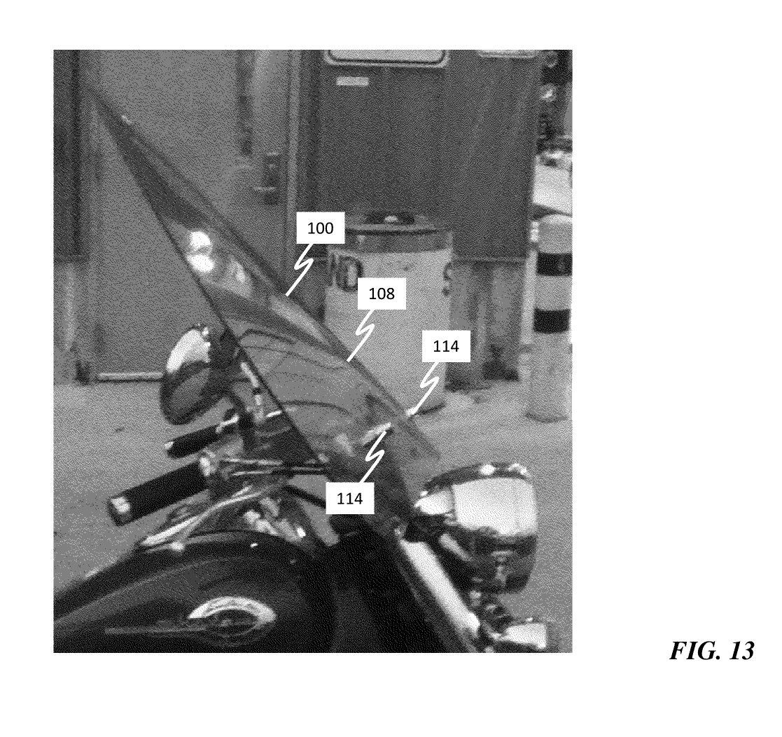

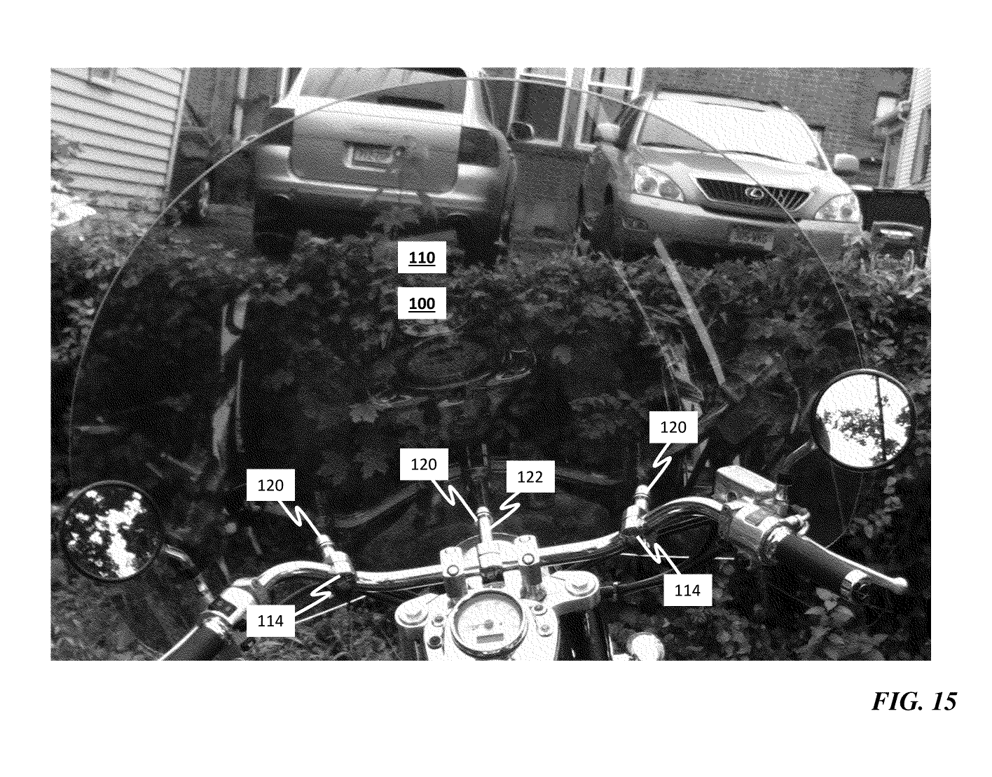

Referring to FIG. 1-FIG. 18, a windscreen 100 is provided in accordance with one embodiment of the invention and includes a screen top 102, a screen bottom 104, screen sides 106, a screen exterior surface 108 and a screen interior surface 110. The screen 100 includes a screen width X and a screen height Y and may be shaped such that points along the width X of the screen bottom 104 lie in substantially the same plane, wherein the width X and/or height Y may vary as desired and/or depending on the size of the rider and/or the size of the vehicle. For example, in one embodiment the screen width X may be between about 2.5 feet to about 4.5 feet and the screen height Y may be between about 2.5 feet to about 4.5 feet The screen sides 106 extend upward in an arcuate manner from the ends of the screen bottom 104 and meet to form the screen top 102, wherein the screen top is also arcuate shaped. It should be appreciated that the windscreen 100 includes a plurality of mounting cavities 112 distributed along the windscreen 100 proximate the screen bottom 104, wherein the plurality of mounting cavities 112 are configured to engage with a plurality of windscreen mounting articles 114 to securely attach the windscreen 100 to the handlebar or frame of a motorcycle.

It should be appreciated that in one embodiment, the screen height H may be equal to the line of sight of the rider plus about four (4) inches (i.e. about 4 inches above the riders line of sight).

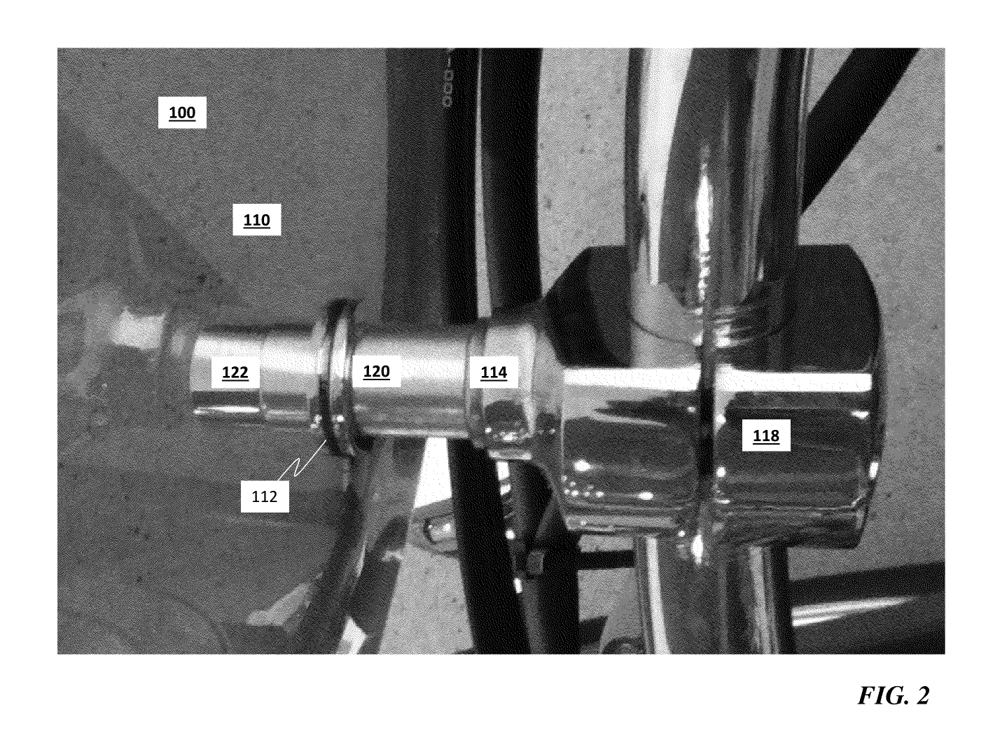

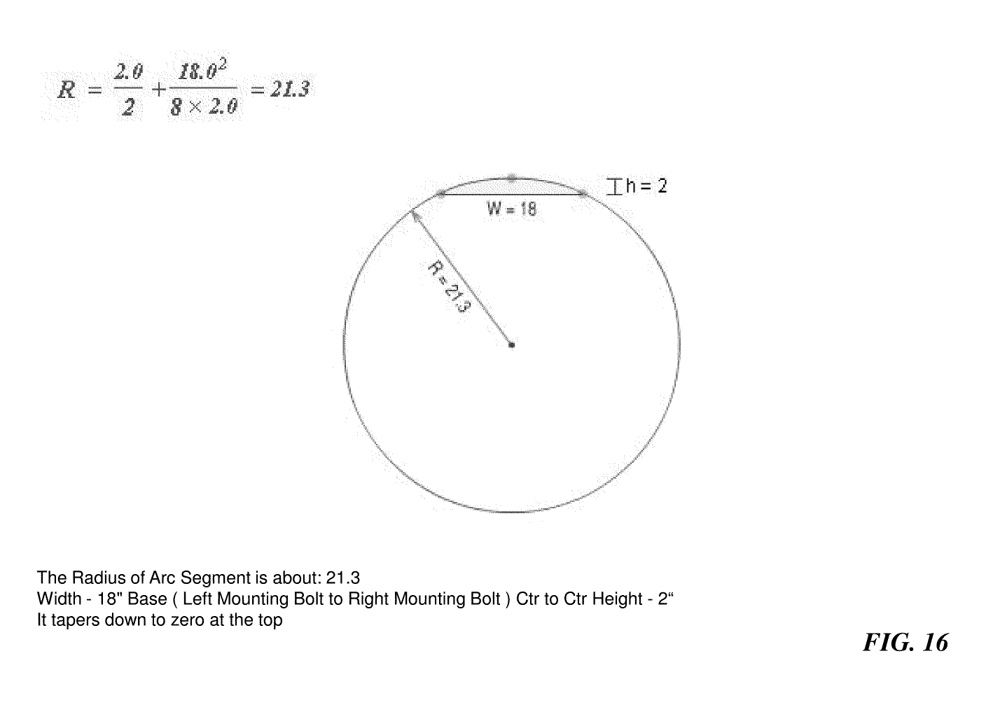

Referring to FIG. 2, each end of the screen bottom 104 and the bottom end of the screen sides 106 may be arcuate shaped such that the transition between the screen bottom 104 and the screen sides 106 are curved (i.e. less than 90 degree angle between the screen bottom 104 and the screen sides 106). Each of the screen sides 106 also includes a middle portion 113 which is substantially straight, wherein each of the middle portion 113 transitions into an upper side portion 116 that is arcuately shaped. The upper side portions 116 extend upwardly in an arcuate manner to meet at and form the screen top 102. In at least one embodiment, the screen 100 may include a continuous curve from one side of the screen 100 to the other side of the screen 100 having an angle of between 0 degrees and 90 degrees. Additionally, in at least one embodiment, the screen 100 may include a continuous curve from the screen top 102 to the screen bottom 104 having an angle of between 0 degrees and 90 degrees In still yet another embodiment, the edge of the screen 100 from one side to the other is between the middle portion 113 on one screen side 106 and the middle portion 113 on the other screen side 106 may be a continuous curve of between 0 degrees and 90 degrees. Furthermore, it should be appreciated that in still yet other embodiments, a portion of the screen may be curved such that the radius of arc segment is about 21.3±10 (See FIG. 16-FIG. 18) where the screen base width (left mounting bolt to right mounting bolt) is about 18 inches (but may be larger or smaller as desired, determined by the width and style of the handle bars). In at least one embodiment, the windscreen 100 is mounted using a universal fit 1 inch riser clamp on the handle bars with a ½ inch threaded tap for attaching the windscreen and two ¼ inch threaded taps on the cap. Dimensions may vary as mentioned herein, but riser clamps with a three point mounting pattern may be used as the installation method.

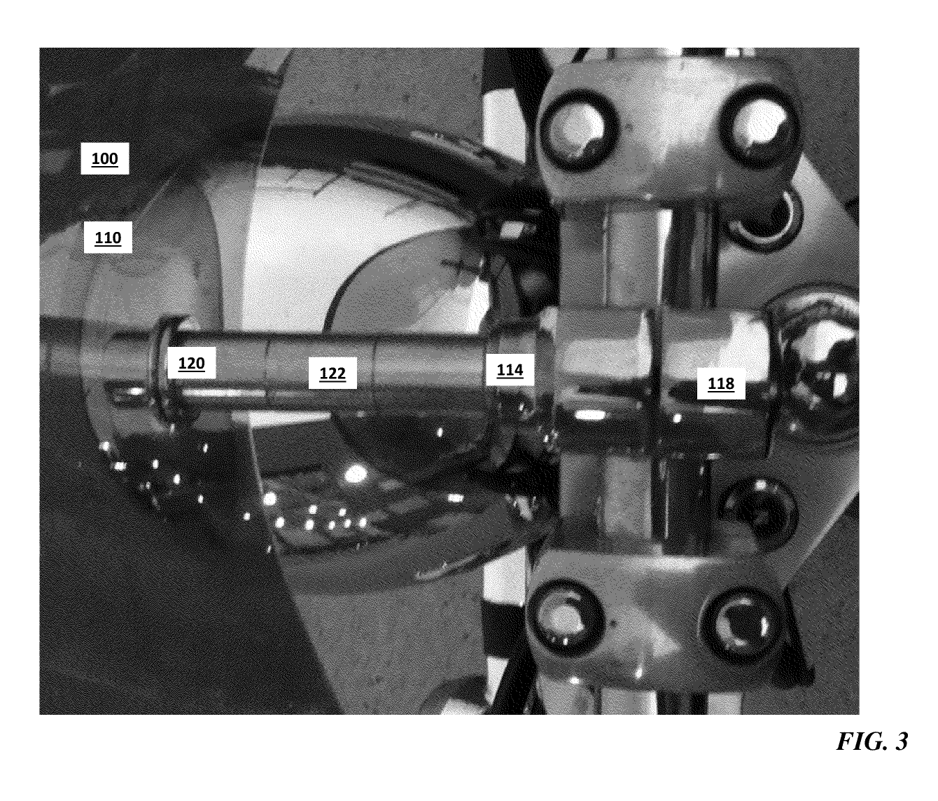

Referring to FIG. 3, the windscreen mounting articles 114 include a handle mount 118 and a windscreen mount 120 connected together via a mounting article shaft 122. The handle mount 118 is configured to non-movably and securely connect with the handle bars of a motorcycle and the windscreen mount 120 is configured to non-movably and securely connect with the windscreen 100 via the plurality of mounting cavities 112. Accordingly, as the handle bars are turned as the motorcycle is being operated the windscreen 100 stays aligned with the handle bars and hence, the forward direction of the motorcycle.

It should be appreciated that the windscreen 100 is configured such that it is arced or angled along the frontal or coronal plane. Accordingly, when mounted to a motorcycle handle bar, the screen sides 106 of the windscreen 100 are angled backward toward the rider. Thus, when viewed along the frontal plane, a center portion of the screen exterior surface 108 is located in one frontal plane and the screen sides 106 of the windscreen 100 are located in a different frontal plane.

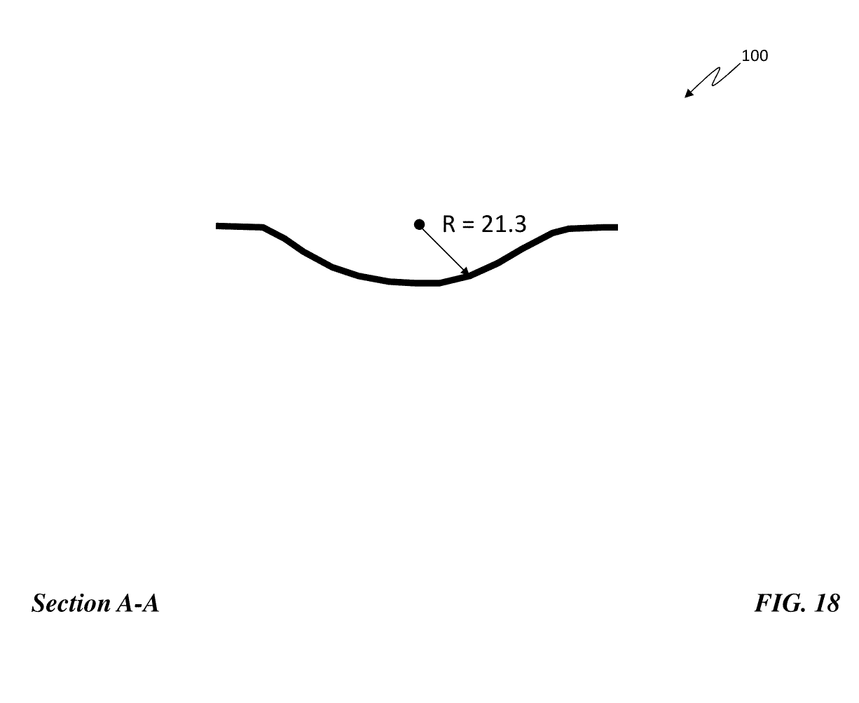

In one embodiment, the area of the windscreen 100 proximate the screen bottom 104 may be wing shaped, as shown in FIG. 18 and may be sized such that the top of the head of the rider is lower than the screen top 102 and the screen sides 106 extend out one either side such that the ends of the handle bars may substantially lie behind the windscreen 100.

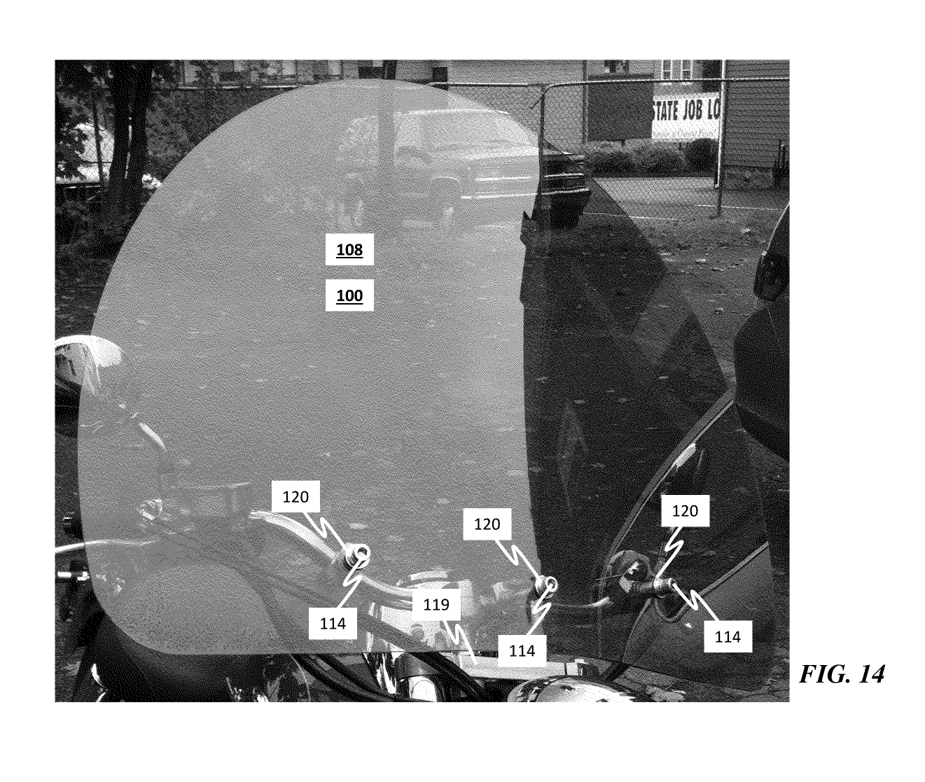

It should be appreciated that in at least one embodiment, the windscreen 100 may be constructed from a polycarbonate material that is about 9½ mm thick and sized such that the screen top 102 is located at least about four (4) inches above the line of sight of the rider. The windscreen 100 may be about 32 inches wide and about 40 inches high. Additionally, the windscreen bottom 104 may be located to be proximate (and substantially parallel with) the top triple tree 119 of the vehicle (see FIG. 14), wherein the handle bar risers may be attached directly to the top of the top triple tree 119. Furthermore, the center mounting bolt of the windscreen mount 120 may be located about three (3) inches above the windscreen bottom 104 and the two side mounting bolts of the windscreen mount 120 may be located about four (4) inches above the windscreen bottom 104. It should be further appreciated that the sides of the windscreen 100 may extend about one (1) inch (or more) past the handle bar grips on either side of the vehicle. It is contemplated that the sizes and dimensions disclosed herein are adjustable to accommodate vehicles, handle bar styles/sizes and/or riders of varying sizes.

It should be appreciated that the radius of the windscreen is given by:

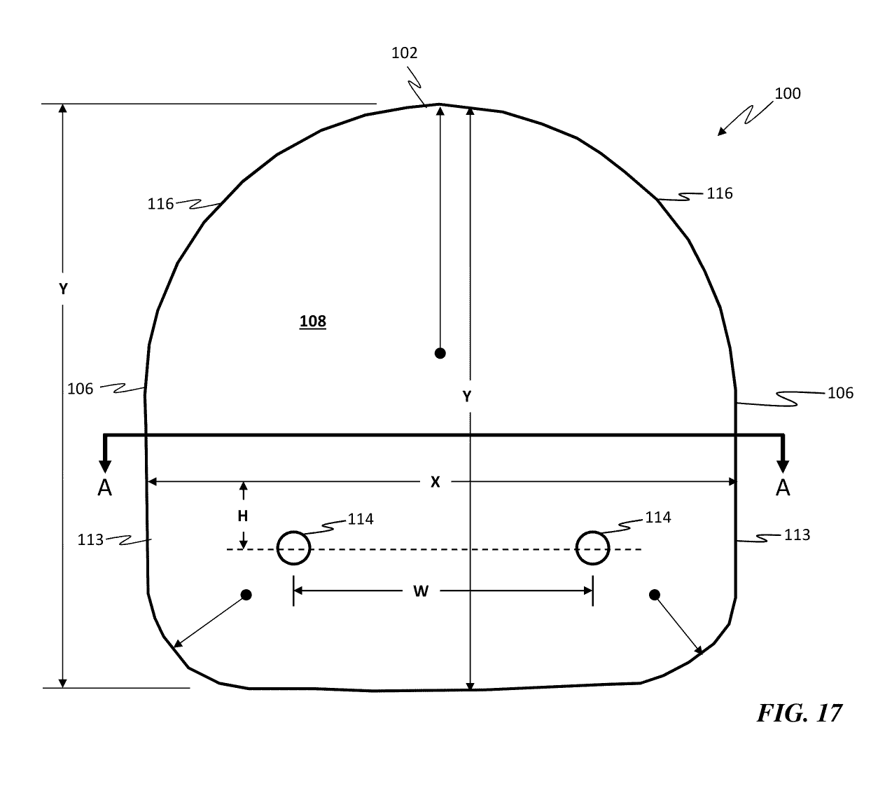

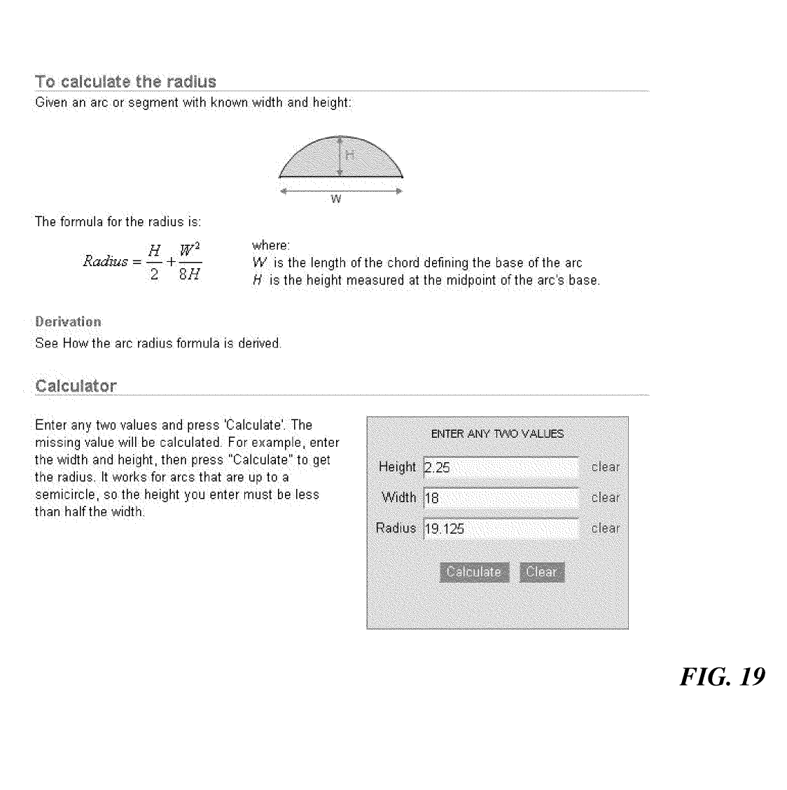

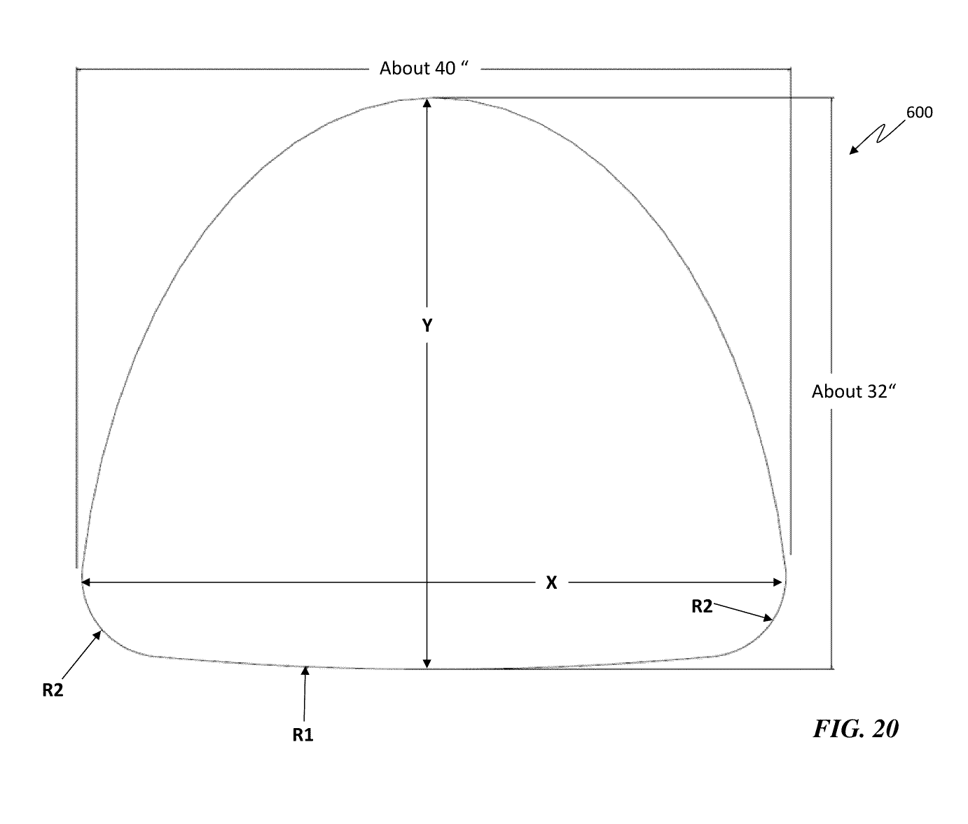

Radius R=(H/2)+(W²/8H),

where, H is the height above an imaginary horizontal plane that passes through the center point of the outer windscreen mounting articles 114 and W is the width between the center points of the outer windscreen mounting articles 114. For example, in one embodiment and referring to FIG. 17-FIG. 19, if the height H is about 2.25 inches and the width W is about 18 inches, then the radius R would be about 19.125. For another example, in another embodiment, if the height H is about 3 inches and the width W is about 17.2 inches, then the radius R would be about 13.83. Referring to FIG. 20, an additional embodiment of the windscreen 600 is shown where the screen height Y is about 32 inches and the screen width X is about 40 inches. The windscreen 600 includes a large radius R1 of about 170 inches and lower corner radius' R2 of about 4.5 inches.

Is should be appreciated that the windscreen 100 may be constructed from at least one of glass, plastic, polycarbonate material and/or a combination thereof. Moreover, it should be appreciated that the dimensions disclosed herein may be modified as desired to achieve a desired end purpose, such as less drag and increased fuel efficiency, performance, etc. Furthermore, the angle of the windscreen 100 may be adjustable for the comfort level of the rider (i.e. normal to the direction of travel or angled (forward or backward) relative to the direction of travel).

Moreover, additional information is provided in the attached appendix where the information does not and is not intended to limit the scope of the invention. Accordingly, all of the information contained herein may be combined together (individually or wholly) or taken singly to achieve varying embodiments of the invention and to add to the scope of the invention without limiting the invention to a particular embodiment. It should be appreciated that the windscreen of the present invention may be used with any type of vehicle suitable to the desired end purpose, such as a motorcycle, a personal water craft, a snowmobile, a bicycle, an all terrain vehicle, etc. . . .

While the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of any appended claims. Moreover, unless specifically stated any use of the terms first, second, etc. do not denote any order or importance, but rather the terms first, second, etc. are used to distinguish one element from another.

What is claimed is:

1. A vehicle windscreen for use with a vehicle having a handle bar, comprising:
a screen top;
a screen bottom, wherein the windscreen includes a screen height which extends between the screen top and the screen bottom;
a first screen side;
a second screen side, wherein the windscreen includes a screen width which extends between the first screen side and the second screen side;
a screen interior surface; and
a screen exterior surface, wherein the screen exterior surface is arcuately shaped such that the screen exterior surface includes a first continuous curve between the first screen side and the second screen side and a second continuos curve between the screen top and the screen bottom.

2. The vehicle windscreen of claim 1, wherein the screen width is between about 2.5 feet wide and about 4.5 feet wide and wherein the screen height is between about 2.5 feet high and about 4.5 feet high.

3. The vehicle windscreen of claim 2, wherein the screen width is about 32 inches wide and about 40 inches high.

4. The vehicle windscreen of claim 1, further including a mounting article, wherein the mounting article includes a windscreen mount, a handle mount and a mounting shaft, wherein the windscreen mount is securely associated with the handle mount via the mounting shaft.

5. The vehicle windscreen of claim 4, wherein the windscreen mount is securely associated with the windscreen and the handle mount is securely associated with the handle bar.

6. The vehicle windscreen of claim 1, wherein the screen top is arcuate in shape and wherein the windscreen further includes an arcuate portion between the first and second screen sides and the screen bottom.

7. The vehicle windscreen of claim 1, where the screen exterior surface between the first and second screen sides is concave shaped.
